(19) United States
(12) Patent Application Publication
(10) Pub. No.: US 2022/0329374 A1
(43) Pub. Date: Oct. 13, 2022

(54) CELL REFERENCE SIGNAL INTERFERENCE REDUCTION

(71) Applicant: AT&T Intellectual Property I, L.P., Atlanta, GA (US)

(72) Inventors: Jianchun Zhou, Bellevue, WA (US); Yakun Gao, Suwanee, GA (US)

(21) Appl. No.: 17/228,793

(22) Filed: Apr. 13, 2021

(51) Int. Cl. H04L 5/00; H04W 72/04

(52) U.S. Cl. CPC H04L 5/0048; H04W 72/0446

(57) ABSTRACT

The described technology is generally directed towards cell reference signal interference reduction. Techniques disclosed herein can be implemented at radio access network (RAN) nodes that use dynamic spectrum sharing (DSS) to send wireless communications according to both a first and a second wireless communication protocol, e.g., according to 4G LTE and 5G NR wireless communication protocols. RAN nodes can limit a cell reference signal transmission rate, thereby reducing interference associated with cell reference signal transmissions.

### TECHNICAL FIELD

The subject application is related to fourth generation (4G), fifth generation (5G), and subsequent generation cellular communication systems, e.g., to techniques to manage cell reference signal transmissions for reduced interference.

### BACKGROUND

Fifth generation new radio (NR) and fourth generation long-term evolution (LTE) co-existence will be the future of wireless communication and will last for an extended period time, until LTE sunset. Dynamic spectrum sharing (DSS), which shares radio resources between NR and LTE, allows the introduction of NR on existing LTE bands without re-farming carriers, and reduces impact on end-user services. But DSS has two large disadvantages for NR, when co-existing with LTE: LTE interference and LTE overhead.

The interference is primarily from LTE cell reference signals (CRS). Studies indicate that interference can cause about 30% throughput degradation. Meanwhile, LTE overhead for DSS deployments can consume about 30% of available radio resources, which leaves about 40% of available radio resources for NR.

However, NR overhead can consume another 21% of available radio resources, leaving real available radio resources for NR user traffic at about 19% of total radio resources. In other words, if operators deploy 10 Megahertz (MHz) DSS spectrum, 60% of it is “wasted” on LTE interference and overhead, with a large resulting impact on DSS performance. Therefore, reduction of LTE interference and overhead are two major areas of focus to improve DSS performance to meet NR goals, such as enhanced mobile broadband (eMBB), massive machine type communications (mMTC) including vehicle-to-everything (V2X) communications, and ultra-reliable low-latency communications (URLLC).

The above-described background is merely intended to provide a contextual overview of some current issues, and is not intended to be exhaustive. Other contextual information may become further apparent upon review of the following detailed description.

### BRIEF DESCRIPTION OF THE DRAWINGS

Non-limiting and non-exhaustive embodiments of the subject disclosure are described with reference to the following figures, wherein like reference numerals refer to like parts throughout the various views unless otherwise specified.

FIG. 1 illustrates an example wireless communication system, in accordance with various aspects and embodiments of the subject disclosure.

FIG. 2 illustrates an example radio frame, in accordance with various aspects and embodiments of the subject disclosure.

FIG. 3 illustrates an example resource block, in accordance with various aspects and embodiments of the subject disclosure.

FIG. 4 illustrates example resource blocks transmitted by neighbor cells, in accordance with various aspects and embodiments of the subject disclosure.

FIG. 5 illustrates example resource blocks transmitted by neighbor cells that employ a shifting pattern for cell reference signal transmissions, in accordance with various aspects and embodiments of the subject disclosure.

FIG. 6 illustrates example interference resulting from cell reference signal transmissions, wherein the interference can be addressed by various aspects and embodiments of the subject disclosure.

FIG. 7 illustrates an example radio frame generator of a network node, in accordance with various aspects and embodiments of the subject disclosure.

FIG. 8 is a flow diagram representing example operations of a network node, in accordance with various aspects and embodiments of the subject disclosure.

FIG. 9 is a flow diagram representing further example operations of a network node, in accordance with various aspects and embodiments of the subject disclosure.

FIG. 10 is a flow diagram representing further example operations of a network node, in accordance with various aspects and embodiments of the subject disclosure.

FIG. 11 is a block diagram of an example computer that can be operable to execute processes and methods in accordance with various aspects and embodiments of the subject disclosure.

### DETAILED DESCRIPTION

One or more embodiments are now described with reference to the drawings, wherein like reference numerals are used to refer to like elements throughout. In the following description, for purposes of explanation, numerous specific details are set forth in order to provide a thorough understanding of the various embodiments. It is evident, however, that the various embodiments can be practiced without these specific details, and without applying to any particular networked environment or standard.

One or more aspects of the technology described herein are generally directed towards cell reference signal interference reduction. In some examples, techniques disclosed herein can be implemented at radio access network (RAN) nodes that use DSS to send wireless communications according to both a first and a second wireless communication protocol, e.g., according to 4G LTE and 5G NR wireless communication protocols. RAN nodes can limit a cell reference signal transmission rate, thereby reducing interference associated with cell reference signal transmissions.

As used in this disclosure, in some embodiments, the terms “component,” “system” and the like are intended to refer to, or comprise, a computer-related entity or an entity related to an operational apparatus with one or more specific functionalities, wherein the entity can be either hardware, a combination of hardware and software, software, or software in execution. As an example, a component can be, but is not limited to being, a process running on a processor, a processor, an object, an executable, a thread of execution, computer-executable instructions, a program, and/or a computer. By way of illustration and not limitation, both an application running on a server and the server can be a component.

One or more components can reside within a process and/or thread of execution and a component can be localized on one computer and/or distributed between two or more computers. In addition, these components can execute from various computer readable media having various data structures stored thereon. The components can communicate via local and/or remote processes such as in accordance with a signal having one or more data packets (e.g., data from one component interacting with another component in a local system, distributed system, and/or across a network such as the internet with other systems via the signal). As another example, a component can be an apparatus with specific functionality provided by mechanical parts operated by electric or electronic circuitry, which is operated by a software application or firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components. While various components have been illustrated as separate components, it will be appreciated that multiple components can be implemented as a single component, or a single component can be implemented as multiple components, without departing from example embodiments.

The term “facilitate” as used herein is in the context of a system, device or component “facilitating” one or more actions or operations, in respect of the nature of complex computing environments in which multiple components and/or multiple devices can be involved in some computing operations. Non-limiting examples of actions that may or may not involve multiple components and/or multiple devices comprise transmitting or receiving data, establishing a connection between devices, determining intermediate results toward obtaining a result, etc. In this regard, a computing device or component can facilitate an operation by playing any part in accomplishing the operation. When operations of a component are described herein, it is thus to be understood that where the operations are described as facilitated by the component, the operations can be optionally completed with the cooperation of one or more other computing devices or components, such as, but not limited to, sensors, antennae, audio and/or visual output devices, other devices, etc.

Further, the various embodiments can be implemented as a method, apparatus or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable (or machine-readable) device or computer-readable (or machine-readable) storage/communications media. For example, computer readable storage media can comprise, but are not limited to, magnetic storage devices (e.g., hard disk, floppy disk, magnetic strips), optical disks (e.g., compact disk (CD), digital versatile disk (DVD)), smart cards, and flash memory devices (e.g., card, stick, key drive). Of course, those skilled in the art will recognize many modifications can be made to this configuration without departing from the scope or spirit of the various embodiments.

Moreover, terms such as “mobile device equipment,” “mobile station,” “mobile,” “subscriber station,” “access terminal,” “terminal,” “handset,” “communication device,” “mobile device” (and/or terms representing similar terminology) can refer to a wireless device utilized by a subscriber or mobile device of a wireless communication service to receive or convey data, control, voice, video, sound, gaming or substantially any data-stream or signaling-stream. The foregoing terms are utilized interchangeably herein and with reference to the related drawings. Likewise, the terms “access point (AP),” “Base Station (BS),” “BS transceiver,” “BS device,” “cell site,” “cell site device,” “gNode B (gNB),” “evolved Node B (eNode B),” “home Node B (HNB)” and the like, refer to wireless network components or appliances that transmit and/or receive data, control, voice, video, sound, gaming or substantially any data-stream or signaling-stream from one or more subscriber stations. Data and signaling streams can be packetized or frame-based flows.

Furthermore, the terms “device,” “communication device,” “mobile device,” “subscriber,” “customer entity,” “consumer,” “customer entity,” “entity” and the like are employed interchangeably throughout, unless context warrants particular distinctions among the terms. It should be appreciated that such terms can refer to human entities or automated components supported through artificial intelligence (e.g., a capacity to make inference based on complex mathematical formalisms), which can provide simulated vision, sound recognition and so forth.

It should be noted that although various aspects and embodiments have been described herein in the context of 4G, 5G, or other next generation networks, the disclosed aspects are not limited to a 4G or 5G implementation, and/or other network next generation implementations, as the techniques can also be applied, for example, in third generation (3G), or other 4G systems. In this regard, aspects or features of the disclosed embodiments can be exploited in substantially any wireless communication technology. Such wireless communication technologies can include universal mobile telecommunications system (UMTS), global system for mobile communication (GSM), code division multiple access (CDMA), wideband CDMA (WCMDA), CDMA2000, time division multiple access (TDMA), frequency division multiple access (FDMA), multi-carrier CDMA (MC-CDMA), single-carrier CDMA (SC-CDMA), single-carrier FDMA (SC-FDMA), orthogonal frequency division multiplexing (OFDM), discrete Fourier transform spread OFDM (DFT-spread OFDM), single carrier FDMA (SC-FDMA), filter bank based multi-carrier (FBMC), zero tail DFT-spread-OFDM (ZT DFT-s-OFDM), generalized frequency division multiplexing (GFDM), fixed mobile convergence (FMC), universal fixed mobile convergence (UFMC), unique word OFDM (UW-OFDM), unique word DFT-spread OFDM (UW DFT-Spread-OFDM), cyclic prefix OFDM (CP-OFDM), resource-block-filtered OFDM, wireless fidelity (Wi-Fi), worldwide interoperability for microwave access (WiMAX), wireless local area network (WLAN), general packet radio service (GPRS), enhanced GPRS, third generation partnership project (3GPP), long term evolution (LTE), LTE frequency division duplex (FDD), time division duplex (TDD), 5G, third generation partnership project 2 (3GPP2), ultra mobile broadband (UMB), high speed packet access (HSPA), evolved high speed packet access (HSPA+), high-speed downlink packet access (HSDPA), high-speed uplink packet access (HSUPA), Zigbee, or another institute of electrical and electronics engineers (IEEE) 802.12 technology. In this regard, all or substantially all aspects disclosed herein can be exploited in legacy telecommunication technologies.

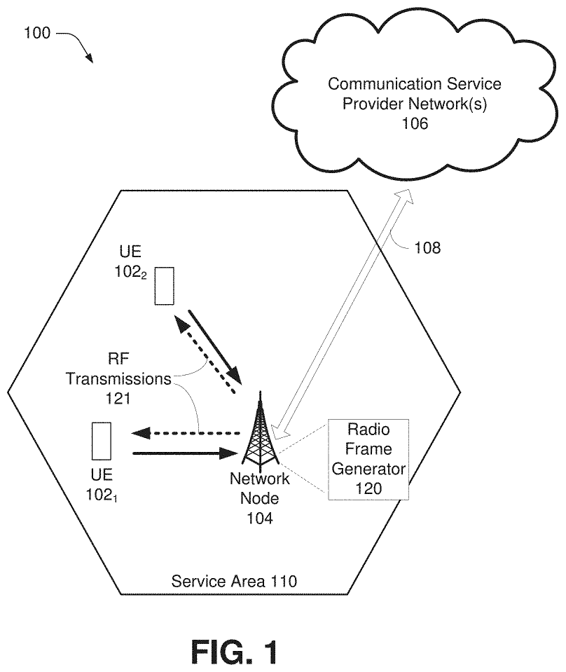

FIG. 1 illustrates a non-limiting example of a wireless communication system 100 which can be used in connection with at least some embodiments of the subject disclosure. In one or more embodiments, system 100 can comprise one or more user equipment UEs 102₁, 102₂, referred to collectively as UEs 102, a network node 104 that supports cellular communications in a service area 110, also known as a cell, and communication service provider network(s) 106.

The non-limiting term “user equipment” can refer to any type of device that can communicate with a network node 104 in a cellular or mobile communication system 100. UEs 102 can have one or more antenna panels having vertical and horizontal elements. Examples of UEs 102 comprise target devices, device to device (D2D) UEs, machine type UEs or UEs capable of machine to machine (M2M) communications, personal digital assistants (PDAs), tablets, mobile terminals, smart phones, laptop mounted equipment (LME), universal serial bus (USB) dongles enabled for mobile communications, computers having mobile capabilities, mobile devices such as cellular phones, laptops having laptop embedded equipment (LEE, such as a mobile broadband adapter), tablet computers having mobile broadband adapters, wearable devices, virtual reality (VR) devices, heads-up display (HUD) devices, smart cars, machine-type communication (MTC) devices, augmented reality head mounted displays, and the like. UEs 102 can also comprise IOT devices that communicate wirelessly.

In various embodiments, system 100 comprises communication service provider network(s) 106 serviced by one or more wireless communication network providers. Communication service provider network(s) 106 can comprise a “core network”. In example embodiments, UEs 102 can be communicatively coupled to the communication service provider network(s) 106 via network node 104. The network node 104 (e.g., network node device) can communicate with UEs 102, thus providing connectivity between the UEs 102 and the wider cellular network. The UEs 102 can send transmission type recommendation data to the network node 104. The transmission type recommendation data can comprise a recommendation to transmit data via a closed loop multiple input multiple output (MIMO) mode and/or a rank-1 precoder mode.

A network node 104 can have a cabinet and other protected enclosures, computing devices, an antenna mast, and multiple antennas for performing various transmission operations (e.g., MIMO operations) and for directing/steering signal beams. Network node 104 can comprise one or more base station devices which implement features of the network node 104. Network nodes can serve several cells, also called sectors or service areas, such as service area 110, depending on the configuration and type of antenna. In example embodiments, UEs 102 can send and/or receive communication data via a wireless link to the network node 104. The dashed arrow lines from the network node 104 to the UEs 102 represent radio frequency (RF) transmissions 121 comprising radio frames generated by a radio frame generator 120 at the network node 104. Radio frames generated by radio frame generator 120 and included in RF transmissions 121 can be configured according to this disclosure. Radio frames may also be referred to as system frames. The radio frames can encode downlink (DL) communications to the UEs 102. The solid arrow lines from the UEs 102 to the network node 104 represents uplink (UL) communications.

Communication service provider networks 106 can facilitate providing wireless communication services to UEs 102 via the network node 104 and/or various additional network devices (not shown) included in the one or more communication service provider networks 106. The one or more communication service provider networks 106 can comprise various types of disparate networks, including but not limited to: cellular networks, femto networks, picocell networks, microcell networks, internet protocol (IP) networks Wi-Fi service networks, broadband service network, enterprise networks, cloud based networks, millimeter wave networks and the like. For example, in at least one implementation, system 100 can be or comprise a large scale wireless communication network that spans various geographic areas. According to this implementation, the one or more communication service provider networks 106 can be or comprise the wireless communication network and/or various additional devices and components of the wireless communication network (e.g., additional network devices and cell, additional UEs, network server devices, etc.).

The network node 104 can be connected to the one or more communication service provider networks 106 via one or more backhaul links 108. For example, the one or more backhaul links 108 can comprise wired link components, such as a T1/E1 phone line, a digital subscriber line (DSL) (e.g., either synchronous or asynchronous), an asymmetric DSL (ADSL), an optical fiber backbone, a coaxial cable, and the like. The one or more backhaul links 108 can also comprise wireless link components, such as but not limited to, line-of-sight (LOS) or non-LOS links which can comprise terrestrial air-interfaces or deep space links (e.g., satellite communication links for navigation). Backhaul links 108 can be implemented via a “transport network” in some embodiments. In another embodiment, network node 104 can be part of an integrated access and backhaul network. This may allow easier deployment of a dense network of self-backhauled 5G cells in a more integrated manner by building upon many of the control and data channels/procedures defined for providing access to UEs.

Wireless communication system 100 can employ various cellular systems, technologies, and modulation modes to facilitate wireless radio communications between devices (e.g., the UE 102 and the network node 104). While example embodiments might be described for 5G new radio (NR) systems, the embodiments can be applicable to any radio access technology (RAT) or multi-RAT system where the UE operates using multiple carriers, e.g., LTE FDD/TDD, GSM/GERAN, CDMA2000 etc.

For example, system 100 can operate in accordance with any 5G, next generation communication technology, or existing communication technologies, various examples of which are listed supra. In this regard, various features and functionalities of system 100 are applicable where the devices (e.g., the UEs 102 and the network device 104) of system 100 are configured to communicate wireless signals using one or more multi carrier modulation schemes, wherein data symbols can be transmitted simultaneously over multiple frequency subcarriers (e.g., OFDM, CP-OFDM, DFT-spread OFMD, UFMC, FMBC, etc.). The embodiments are applicable to single carrier as well as to multicarrier (MC) or carrier aggregation (CA) operation of the UE. The term carrier aggregation (CA) is also called (e.g. interchangeably called) “multi-carrier system”, “multi-cell operation”, “multi-carrier operation”, “multi-carrier” transmission and/or reception. Note that some embodiments are also applicable for Multi RAB (radio bearers) on some carriers (that is data plus speech is simultaneously scheduled).

In various embodiments, system 100 can be configured to provide and employ 5G or subsequent generation wireless networking features and functionalities. 5G wireless communication networks are expected to fulfill the demand of exponentially increasing data traffic and to allow people and machines to enjoy gigabit data rates with virtually zero (e.g., single digit millisecond) latency. Compared to 4G, 5G supports more diverse traffic scenarios. For example, in addition to the various types of data communication between conventional UEs (e.g., phones, smartphones, tablets, PCs, televisions, internet enabled televisions, AR/VR head mounted displays (HMDs), etc.) supported by 4G networks, 5G networks can be employed to support data communication between smart cars in association with driverless car environments, as well as machine type communications (MTCs). Considering the drastic different communication needs of these different traffic scenarios, the ability to dynamically configure waveform parameters based on traffic scenarios while retaining the benefits of multi carrier modulation schemes (e.g., OFDM and related schemes) can provide a significant contribution to the high speed/capacity and low latency demands of 5G networks. With waveforms that split the bandwidth into several sub-bands, different types of services can be accommodated in different sub-bands with the most suitable waveform and numerology, leading to an improved spectrum utilization for 5G networks.

To meet the demand for data centric applications, features of 5G networks can comprise: increased peak bit rate (e.g., 20 Gbps), larger data volume per unit area (e.g., high system spectral efficiency—for example about 3.5 times that of spectral efficiency of long term evolution (LTE) systems), high capacity that allows more device connectivity both concurrently and instantaneously, lower battery/power consumption (which reduces energy and consumption costs), better connectivity regardless of the geographic region in which a user is located, a larger numbers of devices, lower infrastructural development costs, and higher reliability of the communications. Thus, 5G networks can allow for: data rates of several tens of megabits per second should be supported for tens of thousands of users, 1 gigabit per second to be offered simultaneously to tens of workers on the same office floor, for example; several hundreds of thousands of simultaneous connections to be supported for massive sensor deployments; improved coverage, enhanced signaling efficiency; reduced latency compared to LTE.

The 5G access network can utilize higher frequencies (e.g., >6 GHz) to aid in increasing capacity. Currently, much of the millimeter wave (mmWave) spectrum, the band of spectrum between 30 GHz and 300 GHz is underutilized. The millimeter waves have shorter wavelengths that range from 10 millimeters to 1 millimeter, and these mmWave signals experience severe path loss, penetration loss, and fading. However, the shorter wavelength at mmWave frequencies also allows more antennas to be packed in the same physical dimension, which allows for large-scale spatial multiplexing and highly directional beamforming.

Performance can be improved if both the transmitter and the receiver are equipped with multiple antennas. Multi-antenna techniques can significantly increase the data rates and reliability of a wireless communication system. The use of multiple input multiple output (MIMO) techniques, which was introduced in the 3GPP and has been in use (including with LTE), is a multi-antenna technique that can improve the spectral efficiency of transmissions, thereby significantly boosting the overall data carrying capacity of wireless systems. The use of MIMO techniques can improve mmWave communications and has been widely recognized as a potentially important component for access networks operating in higher frequencies. MIMO can be used for achieving diversity gain, spatial multiplexing gain and beamforming gain. For these reasons, MIMO systems are an important part of the 3rd and 4th generation wireless systems and are in use in 5G systems.

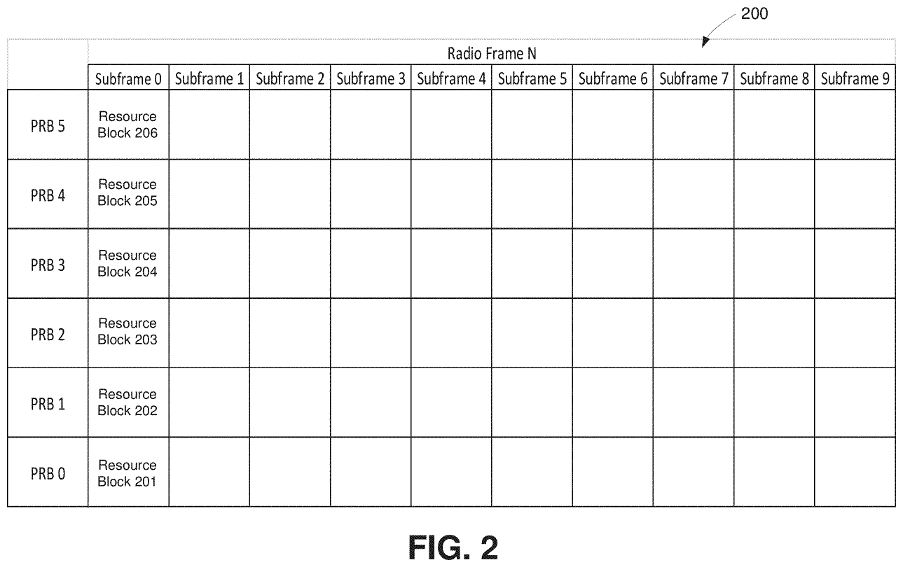

FIG. 2 illustrates an example radio frame, in accordance with various aspects and embodiments of the subject disclosure. The example radio frame 200 can be generated by a radio frame generator 120 at a network node 104 such as illustrated in FIG. 1, and the radio frame 200 can be included in RF transmissions 121 that are transmitted by the network node 104 to UEs 102. The RF transmissions 121 can include multiple radio frames such as radio frame 200. For example, the radio frame 200 can be 10 milliseconds (ms) in length, and the RF transmissions 121 can optionally include one radio frame 200 every 10 ms.

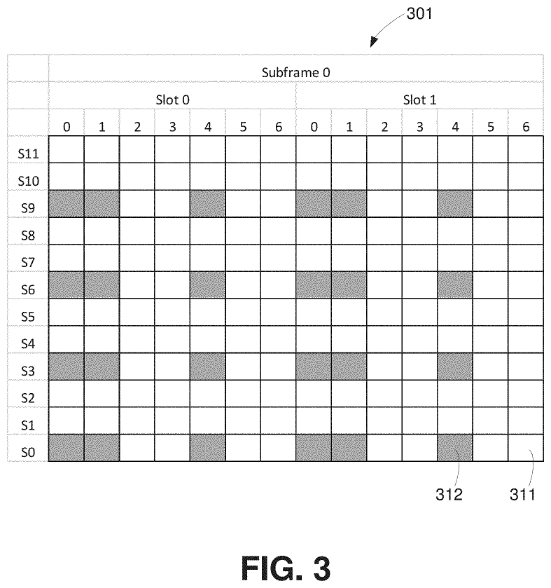

The example radio frame 200 can include multiple time domain subframes, namely, subframes 0-9. Each time domain subframe can have a length, e.g., a 1 ms length. The time domain subframes can each include multiple “symbols”, as described in connection with FIG. 3.

The example radio frame 200 can further include multiple frequency domain physical resource blocks (PRBs), namely, PRBs 0-5. Each PRB can have a frequency bandwidth, e.g., a 180 kilohertz (kHz) frequency bandwidth. The PRBs can each include multiple “subcarriers”, as described in connection with FIG. 3.

The intersection of a time domain subframe and a PRB can define a resource block. FIG. 2 illustrates example resource blocks 201, 202, 203, 204, 205 and 206 in subframe 0. The other subframes 1-9 can also include six resource blocks each (one for each of PRBs 0-5). However, the resource blocks of subframes 1-9 are not illustrated in FIG. 2 for the sake of brevity. An example resource block, which can implement, e.g., resource block 201, is illustrated in FIG. 3.

FIG. 3 illustrates an example resource block, in accordance with various aspects and embodiments of the subject disclosure. The example resource block 301 can implement the resource block 201 introduced in FIG. 2, and similar resource blocks can implement the other resource blocks 202-206 illustrated in FIG. 2. The example resource block 301 is situated at the intersection of subframe 0 and PRB 0, as can be seen by reference to FIG. 2. A resource block is generally the smallest unit of radio resources that can be allocated to a particular UE, e.g., to UE 102₁ or 102₂.

The time domain of the resource block 301 can include multiple symbols. In FIG. 3, the symbols are illustrated as symbols 0-6 in slot 0, and symbols 0-6 in slot 1, for a total of 14 symbols. Because the example resource block 301 is 1 ms long, the length of each symbol is therefore 1/14 ms.

The frequency domain of the resource block 301 can include multiple subcarriers. In FIG. 3, the subcarriers are illustrated as subcarriers S0-S11, for a total of 12 subcarriers. Because the example resource block 301 is 180 kHz wide, the width of each subcarrier is therefore 15 kHz.

The intersection of a symbol and a subcarrier is referred to as a resource element. The example resource block 301 includes 14×12=168 resource elements. Example resource elements 311 and 312 are identified in FIG. 3. A resource element such as 311 is the smallest discrete part of a radio frame 200, and it can contain, e.g., a single complex value representing data from a physical channel or signal.

The shaded resource elements in FIG. 3, such as resource element 312, are example resource elements allocated to cell reference signal (CRS) transmissions. The unshaded resource elements in FIG. 3, such as resource element 311, are example resource elements not allocated to cell reference signal (CRS) transmissions, and therefore, the unshaded resource elements are available to carry other data.

CRS are generally used by UEs, such as UEs 102, for channel estimation and coherent demodulation of downlink physical channels. In some cases, CRS transmissions can be transmitted at a higher power level, e.g., 2 or 3 decibels (dB) higher power than other transmissions. As a result, CRS transmissions such as resource element 312 have a generally high likelihood of interfering with RF transmissions of neighbor network nodes. Such interference can degrade the signal quality of neighbor network nodes, and vice versa.

The resource elements not allocated to CRS transmissions, such as resource element 311, can include any of a variety of other data. For example, resource element 311 can be used for physical downlink control channel (PDCCH) information, demodulation reference signal (DMRS) information, and/or physical downlink shared channel (PDSCH) information.

In view of the interference problems associated with CRS transmissions, embodiments of this disclosure can configure the radio frame generator 120 to limit CRS transmissions. CRS transmissions can be limited to fewer than all of the subframes in a radio frame 200. With reference to FIG. 2, CRS transmissions can be included in, e.g. subframe 0, but not included in subframes 1-9. Alternatively, any of the other subframes, or any multiple subframes, can include CRS transmissions, while at least one remaining subframe does not include CRS transmissions.

In some embodiments, CRS transmissions can be limited to less than one subframe in multiple radio frames. For example, every 2, 3, 4, etc. radio frames 200 can include a subframe with CRS transmissions.

When one subframe per radio frame 200 includes CRS transmissions, the result is including CRS in one-tenth of the subframes, or in one subframe per 10 ms. When one subframe per two radio frames includes CRS transmissions, the result is including CRS in one-twentieth of the subframes, or in one subframe per 20 ms. When one subframe per ten radio frames includes CRS transmissions, the result is including CRS in one one-hundredth of the subframes, or in one subframe per 100 ms. Embodiments can include CRS in a subset of the subframes, wherein the subset of the subframes is above at least a lower threshold fraction (such as 1/100, or 1/20 of the subframes) and below an upper threshold fraction (such as 1/10, or ⅕, or ½) of the subframes.

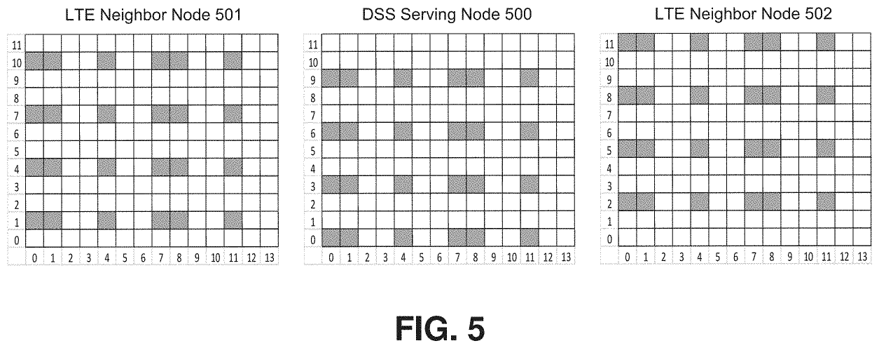

In some embodiments, CRS transmissions can be included in a limited subset of time domain subframes, as discussed above, while CRS transmissions need not be limited in the frequency domain. For example, FIG. 3 shows CRS transmissions on subcarriers S0, S3, S6, and S9. The other resource blocks included in subframe 0 can optionally include a similar distribution of CRS transmissions (e.g., wherein CRS transmissions are made at a bottom subcarrier as well as at a fourth subcarrier, seventh subcarrier, and tenth subcarrier of the resource block). Furthermore, as discussed further in connection with FIG. 5, a network node 104 can optionally shift CRS transmissions so that subsequent CRS transmissions are made on different subcarriers within the resource blocks. Embodiments can, but need not necessarily, limit the subcarriers used for CRS transmissions.

Any group of symbols can be used for CRS transmissions within resource blocks. For example resource blocks 201-206, of a subframe, e.g., subframe 0, which is included in the subset of subframes that include CRS, can each use the example group of gray symbols illustrated in FIG. 3 for CRS transmissions. In FIG. 3, the symbols used for CRS transmissions are symbols 0, 1, and 4 of slot 0, as well as symbols 0, 1, and 4 of slot 1. The illustrated group of symbols is an example and can be modified as appropriate to suit other embodiments.

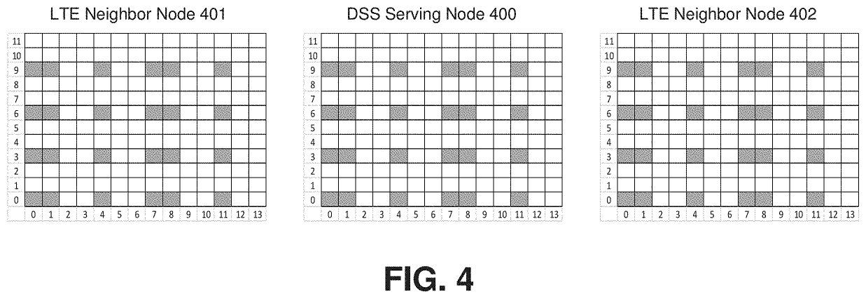

FIG. 4 illustrates example resource blocks transmitted by neighbor cells, in accordance with various aspects and embodiments of the subject disclosure. FIG. 4 illustrates three adjacent example resource blocks. A first resource block is transmitted by an LTE neighbor node 401, a second resource block is transmitted by a DSS serving node 400, and a third resource block is transmitted by an LTE neighbor node 402. The DSS serving node 400 can optionally be configured to use DSS to transmit both LTE and NR resource blocks. The DSS serving node 400 can optionally also limit CRS transmissions according to this disclosure.

In FIG. 4, it can be appreciated that the CRS transmissions included in the resource block transmitted by the DSS serving node 400 can experience interference with the CRS transmissions included in the resource blocks transmitted by the LTE neighbor nodes 401, 402. While limiting the CRS transmissions of DSS serving node 400 to a limited subset of time domain subframes can reduce interference, the limited CRS transmissions can nonetheless occasionally experience interference as illustrated in FIG. 4.

FIG. 5 illustrates example resource blocks transmitted by neighbor cells that employ a shifting pattern for cell reference signal transmissions, in accordance with various aspects and embodiments of the subject disclosure. FIG. 5 illustrates three adjacent example resource blocks. A first resource block is transmitted by an LTE neighbor node 501, a second resource block is transmitted by a DSS serving node 500, and a third resource block is transmitted by an LTE neighbor node 502. The DSS serving node 500 can optionally be configured to use DSS to transmit both LTE and NR resource blocks. The DSS serving node 500 can optionally also limit CRS transmissions according to this disclosure.

In FIG. 5, LTE neighbor node 501, DSS serving node 500, and LTE neighbor node 502 are configured to employ a shifting pattern for CRS transmissions, wherein the subcarriers used for CRS transmissions are shifted with respect to CRS transmissions of neighbor nodes. In the illustrated example, LTE neighbor node 501 uses subcarriers 1, 4, 7, and 10 for CRS transmissions, DSS serving node 500 uses subcarriers 0, 3, 6, and 9 for CRS transmissions, and LTE neighbor node 502 uses subcarriers 2, 5, 8, and 11 for CRS transmissions.

In some embodiments, a shifting pattern for CRS transmissions can be accomplished by configuring neighbor nodes to employ different subcarriers for CRS transmissions, as illustrated in FIG. 5. In some embodiments, each of the neighbor nodes can dynamically shift the subcarriers used for CRS transmissions, e.g., by using a first set of subcarriers for CRS transmissions in a first radio frame, using a second set of subcarriers for CRS transmissions in a second radio frame, using a third set of subcarriers for CRS transmissions in a third radio frame, and so on.

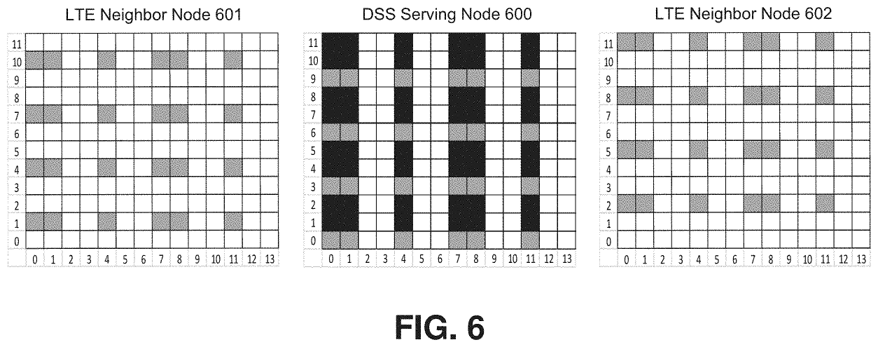

While the use of a shifting pattern for CRS transmissions addresses the problem of colliding (interfering) CRS transmissions described in connection with FIG. 4, such shifting patterns can result in other interference, such as illustrated in FIG. 6. Limiting the CRS transmissions of DSS serving node 500 to a limited subset of time domain subframes, according to this disclosure, is particularly advantageous in the context of shifting CRS transmission patterns, as it reduces interference such as illustrated in FIG. 6.

FIG. 6 illustrates example interference resulting from cell reference signal transmissions, wherein the interference can be addressed by various aspects and embodiments of the subject disclosure. FIG. 6 illustrates three adjacent example resource blocks. A first resource block is transmitted by an LTE neighbor node 601, a second resource block is transmitted by a DSS serving node 600, and a third resource block is transmitted by an LTE neighbor node 602. The DSS serving node 600 can optionally be configured to use DSS to transmit both LTE and NR resource blocks. The DSS serving node 600 can optionally also limit CRS transmissions according to this disclosure.

In FIG. 6, resource elements of the second resource block which may experience interference are indicated in black. The interference within the second resource block is due to the CRS transmissions included in the first and third resource blocks. As can be appreciated, the potential interference problems due to shifting CRS transmissions employed by neighbor nodes can significantly degrade the available resource elements in the second resource block. For this reason, limiting CRS transmissions to a subset of subframes, as described herein, can yield a significant reduction in interference with corresponding efficiency and user experience improvements.

Embodiments of this disclosure provide methods to use periodic CRS transmission, instead of constant CRS transmission per 1 ms transmitting time interval (TTI). The resulting reduction of CRS transmissions can reduce overhead and interference. Initial data suggests that DSS spectrum efficiency can be improved by up to 40%, which results in 60% of radio resources being available for NR users, instead of the current 19%.

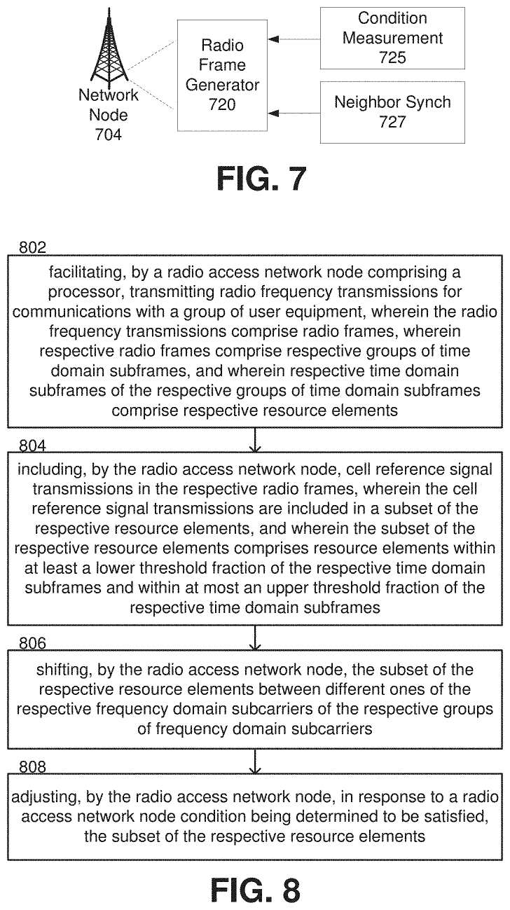

Furthermore, embodiments can potentially reduce interference by up to 90%, if CRS transmissions are sent once every 10 ms, and up to 95%, if CRS transmissions are sent once every 20 ms. Periodic CRS transmission intervals can vary, e.g., as described in connection with FIG. 7. In addition, slots not including CRS transmissions can be used to transmit user data, which can potentially yield up to another 10% throughput gain. In summary, embodiments can potentially improve DSS throughput or spectrum efficiency by up to 40%. Cellular network operators and RAN vendors can therefore maximize returns on DSS investments before migrating to stand-alone 5G.

FIG. 7 illustrates an example radio frame generator of a network node, in accordance with various aspects and embodiments of the subject disclosure. FIG. 7 includes a network node 704, which can implement the network node 104 introduced in FIG. 1. The network node 720 comprises a radio frame generator 720, which can implement the radio frame generator 120 introduced in FIG. 1. The radio frame generator 720 can be configured to receive inputs from condition measurement 725 and neighbor synchronizer 727, and the radio frame generator 720 can modify the CRS transmissions included in radio frames in response to these inputs.

Condition measurement 725 can be configured to measure any of a variety of conditions relevant to adjustment of a CRS transmission rate. A CRS transmission rate can be understood as a number or fraction of time domain subframes that include CRS transmissions, e.g., a number of time domain subframes in a subset of time domain subframes. The measured conditions can comprise radio conditions, such as signal strength measurements. In some embodiments, condition measurement 725 can measure signal strength of signals received from UEs 102. Condition measurement 725 can optionally be configured to calculate an average UE signal strength value. In another example, the measured conditions can include a determination regarding whether UEs 102 are stationary or mobile. Condition measurement 725 can be configured to report condition measurements and/or determinations to radio frame generator 720.

Radio frame generator 720 can be configured to adjust the CRS transmission rate of network node 704 in response to inputs from condition measurement 725. In response to conditions such as poor radio signal strength and/or mobility of UEs 102, the radio frame generator 720 can shorten the interval between subframes that include CRS transmissions. For example, a subframes at intervals of about 2-8 ms can include CRS transmissions. In response to conditions such as good radio signal strength and/or stationary UEs 102, the radio frame generator 720 can increase the interval between subframes that include CRS transmissions. For example, subframes at intervals of about 20-100 ms can include CRS transmissions.

Neighbor synchronizer 727 can be configured to detect CRS transmissions of neighbor nodes. Neighbor synchronizer 727 can be configured to report measurements such as timing and frequencies of neighbor node CRS transmissions to radio frame generator 720.

Radio frame generator 720 can be configured to adjust the CRS transmissions in response to inputs from neighbor synchronizer 727. For example, radio frame generator 720 can implement a shifted/shifting CRS transmission schedule which shifts frequencies of CRS transmissions so as not to overlap with shifted/shifting neighbor node CRS transmission frequencies. Radio frame generator 720 can furthermore adjust timing of subframes that include CRS transmissions in order to reduce a number of CRS transmissions that occur simultaneously with neighbor node CRS transmissions.

FIG. 8 is a flow diagram representing example operations of a network node, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 8 can be performed, for example, by a network node 704 such as illustrated in FIG. 7. Example operation 802 comprises facilitating, by a radio access network node 704 comprising a processor, transmitting radio frequency transmissions 121 for communications with a group of user equipment 102, wherein the radio frequency transmissions 121 comprise radio frames 200, wherein respective radio frames 200 comprise respective groups of time domain subframes (e.g., subframes 0-9), and wherein respective time domain subframes of the respective groups of time domain subframes comprise respective resource elements (such as resource elements 311, 312 included in resource blocks 201-206).

In methods according to FIG. 8, the radio frequency transmissions 121 can comprise first radio frequency transmissions communicated according to a fourth generation network communication protocol and second radio frequency transmissions communicated according to a fifth generation network communication protocol, and the radio access network node 704 can be configured for dynamic spectrum sharing between the first and second radio frequency transmissions.

Example operation 804 comprises including, by the radio access network node 704, cell reference signal transmissions in the respective radio frames 200, wherein the cell reference signal transmissions are included in a subset of the respective resource elements (such as resource element 312), and wherein the subset of the respective resource elements comprises resource elements within at least a lower threshold fraction (e.g., 1/20, or 1/100, or other fraction) of the respective time domain subframes and within at most an upper threshold fraction (e.g., 1/10, or ⅕, or other fraction) of the respective time domain subframes. The cell reference signal transmissions can optionally be at an increased power relative to other transmissions in the respective radio frames 200.

In an embodiment, the lower threshold fraction of the respective time domain subframes can comprise a first fractional value which includes the cell reference signal transmissions in a time domain subframe at least once per twenty milliseconds. When a 10 ms radio frame is used as disclosed herein, including CRS transmissions in 1/20^{th} of the time domain subframes, in other words, in one subframe per two radio frames, results in inclusion of the CRS transmissions in a time domain subframe at least once per 20 ms.

In another embodiment, the upper threshold fraction of the respective time domain subframes can comprise a second fractional value which includes the cell reference signal transmissions in a time domain subframe at most once per ten milliseconds. When a 10 ms radio frame is used as disclosed herein, including CRS transmissions in 1/10^{th} of the time domain subframes, in other words, in one subframe per radio frame, results in inclusion of the CRS transmissions in a time domain subframe at most once per 10 ms.

In FIG. 8, the respective time domain subframes of the respective groups of time domain subframes comprise respective groups of time domain symbols, namely, the symbols used by resource blocks as illustrated in FIG. 3, and the respective resource elements are associated with respective time domain symbols of the respective groups of time domain symbols. Furthermore, the respective radio frames 200 comprise respective groups of frequency domain physical resource blocks (PRBs 0-5) comprising respective groups of frequency domain subcarriers, namely, the subcarriers used by resource blocks as illustrated in FIG. 3, and the respective resource elements, such as resource element 311, are associated with respective frequency domain subcarriers of the respective groups of frequency domain subcarriers.

Example operation 806 comprises shifting, by the radio access network node 704, the subset of the respective resource elements between different ones of the respective frequency domain subcarriers of the respective groups of frequency domain subcarriers. For example, a first frequency domain subcarrier can be used for CRS transmissions in a first radio frame, and a second frequency domain subcarrier can be used for CRS transmissions in a second radio frame, and so on, cycling through frequency domain subcarriers used for CRS transmissions.

Example operation 808 comprises, adjusting, by the radio access network node 704, in response to a radio access network node condition being determined to be satisfied, the subset of the respective resource elements. For example, in response to condition measurement 725 measuring poor radio signal quality, the radio frame generator 720 can increase a cell reference signal transmission rate by increasing the fraction of subframes that include CRS transmissions. In response to condition measurement 725 measuring good radio signal quality, the radio frame generator 720 can decrease a cell reference signal transmission rate.

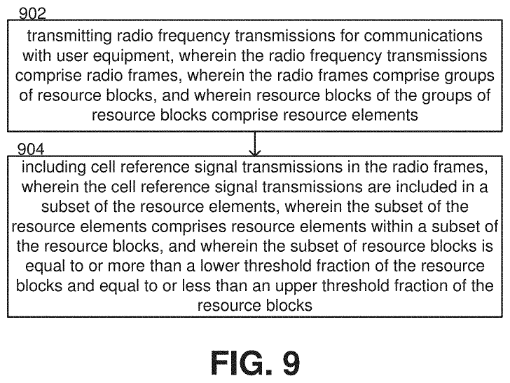

FIG. 9 is a flow diagram representing further example operations of a network node, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 9 can be performed, for example, by a network node 704 such as illustrated in FIG. 7. Example operation 902 comprises transmitting radio frequency transmissions 121 for communications with user equipment 102, wherein the radio frequency transmissions 121 comprise radio frames 200, wherein the radio frames 200 comprise groups of resource blocks, e.g., 201-206, as well as other resource blocks not identified in FIG. 2, and wherein resource blocks of the groups of resource blocks 201-206, etc., comprise resource elements, such as resource elements 311 and 312.

Example operation 904 comprises including CRS transmissions in the radio frames 200, wherein the cell reference signal transmissions are included in a subset of the resource elements, e.g., resource elements 312 and the other gray resource elements illustrated in FIG. 3, wherein the subset of the resource elements comprises resource elements within a subset of the resource blocks, e.g., resource blocks 201-206, which is a subset of the resource blocks included in radio frame 200, and wherein the subset of resource blocks 201-206 is equal to or more than a lower threshold fraction of the resource blocks and equal to or less than an upper threshold fraction of the resource blocks.

The subset of the resource elements can comprise resource elements within a single time domain subframe, e.g., subframe 0, or another single subframe, of each radio frame 200. Alternatively, including the cell reference signal transmissions in the radio frames 200 can comprise including the cell reference signal transmissions in fewer than all of the radio frames 200, e.g., by including CRS transmissions in one radio frame out of multiple radio frames. Furthermore, including the CRS transmissions in the radio frames 200 can comprise including CRS transmissions within multiple time domain subframes, but less than all of the time domain subframes, of each radio frame 200.

In an example, the upper threshold fraction of the resource blocks can include the cell reference signal transmissions in a resource block at most once per ten milliseconds, e.g., in 1/10^{th} of the resource blocks, or resource blocks of one subframe per radio frame. The lower threshold fraction of the resource blocks can include the cell reference signal transmissions in a resource block at least once per 20 or more milliseconds, e.g., in 1/20^{th} of the resource blocks, or resource blocks of one subframe per two radio frames. Embodiments can modify the above example by raising or lowering the upper threshold fraction and/or the lower threshold fraction.

In some embodiments, the inclusion of CRS transmissions in about 1/10^{th} of subframes can be used as a default, in order to reduce about 90% of CRS interference. The ratio/fraction can be adjusted based on UE mobility speed. If a UE is primarily stationary, CRS transmissions can be included in as few as 1/100^{th} of subframes, or if UE mobility speed is higher, e.g., higher than a predetermined speed threshold such as 100 km/hour, CRS transmissions can be included in as many as ⅕^{th} of subframes.

As can be understood by reference to FIG. 2 and FIG. 3, each resource block of the groups of resource blocks 201-206, etc., can be defined as an intersection of a time domain subframe comprising a group of time domain symbols, and a frequency domain physical resource block comprising a group of frequency domain subcarriers. The resource elements can be each defined as an intersection of a time domain symbol and a frequency domain subcarrier, as shown in FIG. 3. The subset of the resource elements that include CRS transmissions can comprise resource elements associated with intersections of a selected time domain symbol (or multiple time domain symbols, as shown in FIG. 3) and multiple selected frequency domain subcarriers.

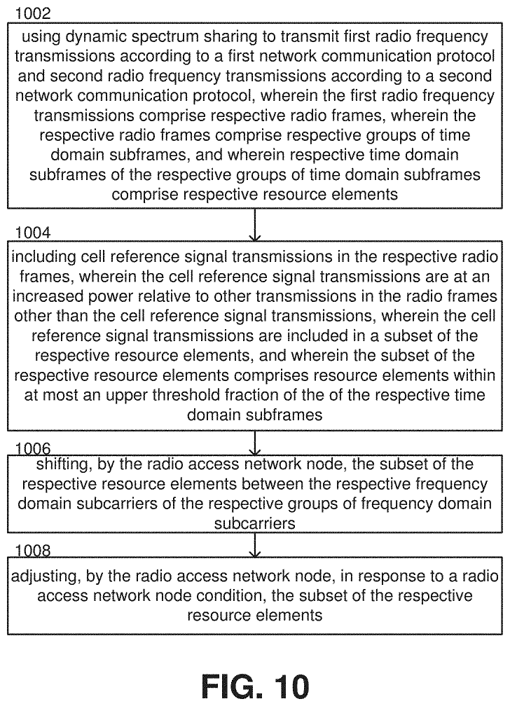

FIG. 10 is a flow diagram representing further example operations of a network node, in accordance with various aspects and embodiments of the subject disclosure. The illustrated blocks can represent actions performed in a method, functional components of a computing device, or instructions implemented in a machine-readable storage medium executable by a processor. While the operations are illustrated in an example sequence, the operations can be eliminated, combined, or re-ordered in some embodiments.

The operations illustrated in FIG. 10 can be performed, for example, by a network node 704 such as illustrated in FIG. 7. Example operation 1002 comprises using dynamic spectrum sharing to transmit first radio frequency transmissions 121 according to a first network communication protocol, such as 4G LTE, and second radio frequency transmissions 121 according to a second network communication protocol, such as 5G NR, wherein the first radio frequency transmissions comprise respective radio frames 200, wherein the respective radio frames comprise respective groups of time domain subframes, e.g., subframes 0-9, and wherein respective time domain subframes of the respective groups of time domain subframes comprise respective resource elements, e.g., resource elements in resource blocks 201-206.

Example operation 1004 comprises including cell reference signal transmissions in the respective radio frames 200, wherein the cell reference signal transmissions are at an increased power relative to other transmissions in the radio frames 200 other than the cell reference signal transmissions, wherein the cell reference signal transmissions are included in a subset of the respective resource elements, e.g., the gray resource elements illustrated in FIG. 3, and wherein the subset of the respective resource elements comprises resource elements within at most an upper threshold fraction of the of the respective time domain subframes. The upper threshold fraction of the of the respective time domain subframes can be, e.g., 1/10^{th}, ⅕^{th}, or any other fraction as may be desired for particular embodiments.

In FIG. 10, the respective time domain subframes of the respective groups of time domain subframes comprise respective groups of time domain symbols, e.g., the symbols shown in FIG. 3, and the respective resource elements are associated with respective time domain symbols of the respective groups of time domain symbols. Furthermore, the respective radio frames 200 comprise respective groups of frequency domain physical resource blocks (PRBs), comprising respective groups of frequency domain subcarriers, such as subcarriers S0-S11 illustrated in FIG. 3, and the respective resource elements are associated with respective frequency domain subcarriers of the respective groups of frequency domain subcarriers.

Example operation 1006 comprises shifting, by the radio access network node 704, the subset of the respective resource elements between the respective frequency domain subcarriers of the respective groups of frequency domain subcarriers. The shifting can change subcarrier frequencies used for CRS transmissions, in coordination with one or more neighbor nodes.

Example operation 1008 comprises adjusting, by the radio access network node 704, in response to a radio access network node condition, the subset of the respective resource elements. For example, the network node 704 can decrease a cell reference signal transmission rate by including CRS transmissions in fewer resource blocks, in response to good radio conditions measured by condition measurement, and vice versa.

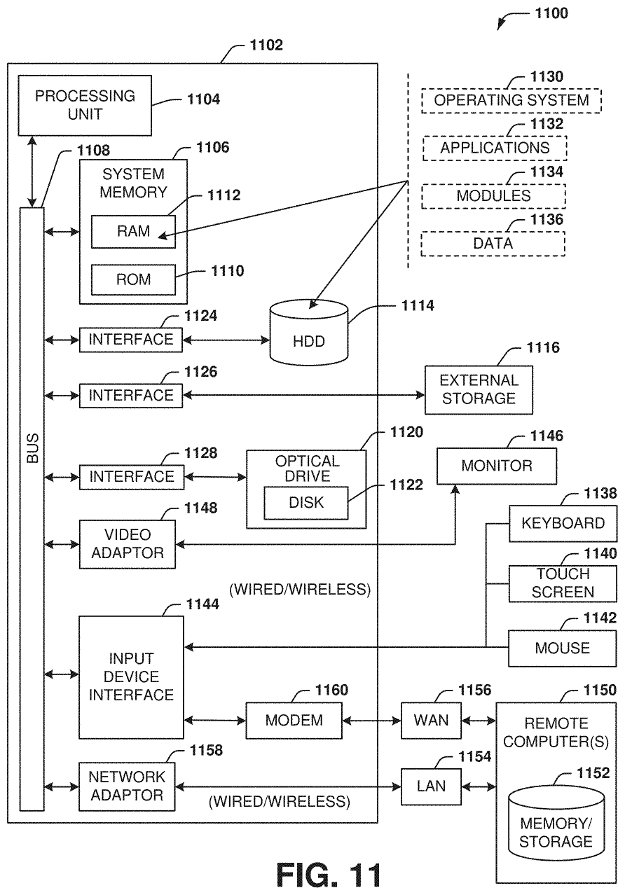

FIG. 11 is a block diagram of an example computer that can be operable to execute processes and methods in accordance with various aspects and embodiments of the subject disclosure. The example computer can be adapted to implement, for example, any of the various network equipment described herein.

FIG. 11 and the following discussion are intended to provide a brief, general description of a suitable computing environment 1100 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the methods can be practiced with other computer system configurations, including single-processor or multiprocessor computer systems, minicomputers, mainframe computers, IoT devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), smart card, flash memory (e.g., card, stick, key drive) or other memory technology, compact disk (CD), compact disk read only memory (CD-ROM), digital versatile disk (DVD), Blu-ray™ disc (BD) or other optical disk storage, floppy disk storage, hard disk storage, magnetic cassettes, magnetic strip(s), magnetic tape, magnetic disk storage or other magnetic storage devices, solid state drives or other solid state storage devices, a virtual device that emulates a storage device (e.g., any storage device listed herein), or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 11, the example environment 1100 for implementing various embodiments of the aspects described herein includes a computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures can also be employed as the processing unit 1104.

The system bus 1108 can be any of several types of bus structure that can further interconnect to a memory bus (with or without a memory controller), a peripheral bus, and a local bus using any of a variety of commercially available bus architectures. The system memory 1106 includes ROM 1110 and RAM 1112. A basic input/output system (BIOS) can be stored in a non-volatile memory such as ROM, erasable programmable read only memory (EPROM), EEPROM, which BIOS contains the basic routines that help to transfer information between elements within the computer 1102, such as during startup. The RAM 1112 can also include a high-speed RAM such as static RAM for caching data.

The computer 1102 further includes an internal hard disk drive (HDD) 1114 (e.g., EIDE, SATA), one or more external storage devices 1116 (e.g., a magnetic floppy disk drive (FDD) 1116, a memory stick or flash drive reader, a memory card reader, etc.) and an optical disk drive 1120 (e.g., which can read or write from a CD-ROM disc, a DVD, a BD, etc.). While the internal HDD 1114 is illustrated as located within the computer 1102, the internal HDD 1114 can also be configured for external use in a suitable chassis (not shown). Additionally, while not shown in environment 1100, a solid state drive (SSD) could be used in addition to, or in place of, an HDD 1114. The HDD 1114, external storage device(s) 1116 and optical disk drive 1120 can be connected to the system bus 1108 by an HDD interface 1124, an external storage interface 1126 and an optical drive interface 1128, respectively. The interface 1124 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1102, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. The systems and methods described herein can be implemented utilizing various commercially available operating systems or combinations of operating systems.

Computer 1102 can optionally comprise emulation technologies. For example, a hypervisor (not shown) or other intermediary can emulate a hardware environment for operating system 1130, and the emulated hardware can optionally be different from the hardware illustrated in FIG. 11. In such an embodiment, operating system 1130 can comprise one virtual machine (VM) of multiple VMs hosted at computer 1102. Furthermore, operating system 1130 can provide runtime environments, such as the Java runtime environment or the .NET framework, for applications 1132. Runtime environments are consistent execution environments that allow applications 1132 to run on any operating system that includes the runtime environment. Similarly, operating system 1130 can support containers, and applications 1132 can be in the form of containers, which are lightweight, standalone, executable packages of software that include, e.g., code, runtime, system tools, system libraries and settings for an application.

Further, computer 1102 can be enabled with a security module, such as a trusted processing module (TPM). For instance with a TPM, boot components hash next in time boot components, and wait for a match of results to secured values, before loading a next boot component. This process can take place at any layer in the code execution stack of computer 1102, e.g., applied at the application execution level or at the operating system (OS) kernel level, thereby enabling security at any level of code execution.

A user can enter commands and information into the computer 1102 through one or more wired/wireless input devices, e.g., a keyboard 1138, a touch screen 1140, and a pointing device, such as a mouse 1142. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1104 through an input device interface 1144 that can be coupled to the system bus 1108, but can be connected by other interfaces, such as a parallel port, an IEEE 1394 serial port, a game port, a USB port, an IR interface, a BLUETOOTH® interface, etc.

A monitor 1146 or other type of display device can be also connected to the system bus 1108 via an interface, such as a video adapter 1148. In addition to the monitor 1146, a computer typically includes other peripheral output devices (not shown), such as speakers, printers, etc.

The computer 1102 can operate in a networked environment using logical connections via wired and/or wireless communications to one or more remote computers, such as a remote computer(s) 1150. The remote computer(s) 1150 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1152 is illustrated. The logical connections depicted include wired/wireless connectivity to a local area network (LAN) 1154 and/or larger networks, e.g., a wide area network (WAN) 1156. Such LAN and WAN networking environments are commonplace in offices and companies, and facilitate enterprise-wide computer networks, such as intranets, all of which can connect to a global communications network, e.g., the internet.

When used in a LAN networking environment, the computer 1102 can be connected to the local network 1154 through a wired and/or wireless communication network interface or adapter 1158. The adapter 1158 can facilitate wired or wireless communication to the LAN 1154, which can also include a wireless access point (AP) disposed thereon for communicating with the adapter 1158 in a wireless mode.

When used in a WAN networking environment, the computer 1102 can include a modem 1160 or can be connected to a communications server on the WAN 1156 via other means for establishing communications over the WAN 1156, such as by way of the internet. The modem 1160, which can be internal or external and a wired or wireless device, can be connected to the system bus 1108 via the input device interface 1144. In a networked environment, program modules depicted relative to the computer 1102 or portions thereof, can be stored in the remote memory/storage device 1152. It will be appreciated that the network connections shown are example and other means of establishing a communications link between the computers can be used.

When used in either a LAN or WAN networking environment, the computer 1102 can access cloud storage systems or other network-based storage systems in addition to, or in place of, external storage devices 1116 as described above. Generally, a connection between the computer 1102 and a cloud storage system can be established over a LAN 1154 or WAN 1156 e.g., by the adapter 1158 or modem 1160, respectively. Upon connecting the computer 1102 to an associated cloud storage system, the external storage interface 1126 can, with the aid of the adapter 1158 and/or modem 1160, manage storage provided by the cloud storage system as it would other types of external storage. For instance, the external storage interface 1126 can be configured to provide access to cloud storage sources as if those sources were physically connected to the computer 1102.

The computer 1102 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art can recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any aspect or design described herein as “exemplary” and/or “demonstrative” is not necessarily to be construed as preferred or advantageous over other aspects or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A method, comprising:
facilitating, by a radio access network node comprising a processor, transmitting radio frequency transmissions for communications with a group of user equipment, wherein the radio frequency transmissions comprise radio frames, wherein respective radio frames comprise respective groups of time domain subframes, and wherein respective time domain subframes of the respective groups of time domain subframes comprise respective resource elements; and
including, by the radio access network node, cell reference signal transmissions in the respective radio frames, wherein the cell reference signal transmissions are included in a subset of the respective resource elements, and wherein the subset of the respective resource elements comprises resource elements within at least a lower threshold fraction of the respective time domain subframes and within at most an upper threshold fraction of the respective time domain subframes.

2. The method of claim 1, wherein the lower threshold fraction of the respective time domain subframes comprises a first fractional value which includes the cell reference signal transmissions in a time domain subframe at least once per twenty milliseconds.

3. The method of claim 1, wherein the upper threshold fraction of the respective time domain subframes comprises a second fractional value which includes the cell reference signal transmissions in a time domain subframe at most once per ten milliseconds.

4. The method of claim 1, wherein the respective time domain subframes of the respective groups of time domain subframes comprise respective groups of time domain symbols, and wherein the respective resource elements are associated with respective time domain symbols of the respective groups of time domain symbols.

5. The method of claim 4, wherein the respective radio frames comprise respective groups of frequency domain physical resource blocks comprising respective groups of frequency domain subcarriers, and wherein the respective resource elements are associated with respective frequency domain subcarriers of the respective groups of frequency domain subcarriers.

6. The method of claim 5, further comprising shifting, by the radio access network node, the subset of the respective resource elements between different ones of the respective frequency domain subcarriers of the respective groups of frequency domain subcarriers.

7. The method of claim 1, wherein the radio frequency transmissions comprise first radio frequency transmissions communicated according to a fourth generation network communication protocol and second radio frequency transmissions communicated according to a fifth generation network communication protocol, and wherein the radio access network node is configured for dynamic spectrum sharing between the first and second radio frequency transmissions.

8. The method of claim 1, further comprising, in response to a radio access network node condition being determined to be satisfied, adjusting, by the radio access network node, the subset of the respective resource elements to increase a cell reference signal transmission rate.

9. The method of claim 1, wherein the cell reference signal transmissions are at an increased power relative to other transmissions in the respective radio frames, other than the cell reference signal transmissions.

10. Radio access network equipment, comprising:
a processor; and
a memory that stores executable instructions that, when executed by the processor, facilitate performance of operations, comprising:
transmitting radio frequency transmissions for communications with user equipment, wherein the radio frequency transmissions comprise radio frames, wherein the radio frames comprise groups of resource blocks, and wherein resource blocks of the groups of resource blocks comprise resource elements; and
including cell reference signal transmissions in the radio frames, wherein the cell reference signal transmissions are included in a subset of the resource elements, wherein the subset of the resource elements comprises resource elements within a subset of the resource blocks, and wherein the subset of resource blocks is equal to or more than a lower threshold fraction of the resource blocks and equal to or less than an upper threshold fraction of the resource blocks.

11. The radio access network equipment of claim 10, wherein each resource block of the groups of resource blocks is defined as an intersection of a time domain subframe comprising a group of time domain symbols, and a frequency domain physical resource block comprising a group of frequency domain subcarriers, and wherein the resource elements are each defined as an intersection of a time domain symbol and a frequency domain subcarrier.

12. The radio access network equipment of claim 11, wherein the subset of the resource elements comprises resource elements associated with intersections of a selected time domain symbol and multiple selected frequency domain subcarriers.

13. The radio access network equipment of claim 11, wherein the subset of the resource elements comprises resource elements within a single time domain subframe of each radio frame of the radio frames.

14. The radio access network equipment of claim 10, wherein including the cell reference signal transmissions in the radio frames comprises including the cell reference signal transmissions in fewer than all of the radio frames.

15. The radio access network equipment of claim 10, wherein the upper threshold fraction of the resource blocks includes the cell reference signal transmissions in a resource block at most once per ten milliseconds.

16. A non-transitory machine-readable medium, comprising executable instructions that, when executed by a processor of a network node, facilitate performance of operations, comprising:
using dynamic spectrum sharing to transmit first radio frequency transmissions according to a first network communication protocol and second radio frequency transmissions according to a second network communication protocol,
wherein the first radio frequency transmissions comprise respective radio frames, wherein the respective radio frames comprise respective groups of time domain subframes, and wherein respective time domain subframes of the respective groups of time domain subframes comprise respective resource elements; and
including cell reference signal transmissions in the respective radio frames, wherein the cell reference signal transmissions are at an increased power relative to other transmissions in the radio frames other than the cell reference signal transmissions, wherein the cell reference signal transmissions are included in a subset of the respective resource elements, and wherein the subset of the respective resource elements comprises resource elements within at most an upper threshold fraction of the of the respective time domain subframes.

17. The non-transitory machine-readable medium of claim 16, wherein the respective time domain subframes of the respective groups of time domain subframes comprise respective groups of time domain symbols, and wherein the respective resource elements are associated with respective time domain symbols of the respective groups of time domain symbols.

18. The non-transitory machine-readable medium of claim 17, wherein the respective radio frames comprise respective groups of frequency domain physical resource blocks, comprising respective groups of frequency domain subcarriers, and wherein the respective resource elements are associated with respective frequency domain subcarriers of the respective groups of frequency domain subcarriers.

19. The non-transitory machine-readable medium of claim 18, wherein the operations further comprise shifting, by the radio access network node, the subset of the respective resource elements between the respective frequency domain subcarriers of the respective groups of frequency domain subcarriers.

20. The non-transitory machine-readable medium of claim 16, wherein the operations further comprise adjusting, by the radio access network node, in response to a radio access network node condition, the subset of the respective resource elements to decrease a cell reference signal transmission rate.
